(19) United States
(12) Patent Application Publication
(10) Pub. No.: US 2019/0354612 A1
(43) Pub. Date: Nov. 21, 2019

(54) SYSTEM, APPARATUS, AND METHOD FOR EFFICIENTLY MANAGING MEMORY OF ELECTRONIC DEVICES

(71) Applicant: NUWA Technologies S.R.L., Pordenone (IT)

(72) Inventors: Massimo Alessandro SANTIN, Pasiano di Pordenone (IT); Keivan Francesco DJAFARI ZAD, San Giovanni di Polcenigo (IT)

(21) Appl. No.: 15/980,891

(22) Filed: May 16, 2018

(51) Int. Cl. G06F 17/30

(52) U.S. Cl. CPC G06F 17/30303; G06F 17/30377

(57) ABSTRACT

Embodiments in accordance with the present disclosure disclose an apparatus connected with a network that comprises one or more processors, a network interface module for connecting the apparatus with the network, and a memory including a database and an instruction set. The database includes a plurality of parent data files, wherein the parent data files are composed of a plurality of child data sets. The instruction set includes instructions which, when executed by the one or more processors, causes the apparatus to modify a child data set of a parent data file, store modified child data set separately in the local memory as a version of the child data set, and enable access to the parent data file with and without the modified child data set.

### FIELD OF THE INVENTION

Embodiments of the present disclosure in general, concern a system, apparatus, and method to efficiently manage memory of electronic devices. More particularly, embodiments of the present disclosure enables an electronic device to reduce data redundancy.

### BACKGROUND OF THE INVENTION

With the advancements in the digital field of technology, the demand for storing data has increased rapidly.

Traditionally, owners of computers, laptops, phone, etc. used to store data in local storage media or on portable media such as hard disks, compact disks, USB storage devices, etc.

However, such devices are not ideal in protecting data as they are prone to crash and theft. Moreover, their capabilities of storing data is limited.

Therefore, remote servers came into existence as an ideal solution for storing important data with complete safety.

However, the usage of remote servers became so popular that it became very hard for companies to keep expanding their servers to meet the demand.

Also, maintenance of the remote servers is expensive.

It is well known that if data redundancy can be optimized then a lot of storage space can be saved and cost of maintaining non-redundant data will be very economical in comparison.

Therefore, there is a need for a system and method that is capable of reducing data redundancy in storage devices such as remote data servers.

The applicant has devised, tested and embodied the present disclosure to overcome the shortcomings of the state of the art and to obtain these and other purposes and advantages.

### SUMMARY OF THE INVENTION

Embodiments in accordance with the present disclosure disclose a method to manage a local memory of an electronic device storing a plurality of parent data files, wherein the parent data files are composed of a plurality of child data sets.

The method enables the electronic device to modify a child data set of a parent data file, store modified child data set separately in the local memory as a version of the child data set, and enable access to the parent data file with and without the modified child data set.

The method further enables the electronic device to determine if at least one parameter of the modified child data set crossed a threshold limit, divide the modified child data set into two or more new data sets based on the threshold limit, store the new child data sets separately as a version of the modified child data set, and enable access to the parent data file with the modified child data set and with the new child data sets.

The method further enables the electronic device to determine if at least one parameter of the modified child data set is below a threshold limit, join the modified child data set with its sequential child data set to form a new child data set, store the new child data set separately as a version of the modified child data set, and enable access to the parent data file with the modified child data set and with the new child data set.

The method further may provide to retrieve arbitrary information related to a parent data file and/or a child data file and/or a sub-child data file in order to calculate and provide the rights ownership for each author that has worked on the specific data file, said rights ownership being expressed as percentages.

Similarly, the method further enables the electronic device to modify the one or more sub-child data sets, store the modified sub-child data sets separately in the local memory as a version of the one or more sub-child data sets, and enable access to the parent data file with and without the modified sub-child data sets.

Embodiments in accordance with the present disclosure disclose an apparatus connected with a network that comprises one or more processors, a network interface module for connecting the apparatus with the network, and a memory comprising a database and an instruction set.

The database comprising a plurality of parent data files, wherein the parent data files are composed of a plurality of child data sets. The instruction set comprising instructions which when executed by the one or more processors causes the apparatus to modify a child data set of a parent data file, store modified child data set separately in the local memory as a version of the child data set, and enable access to the parent data file with and without the modified child data set.

The instruction set further comprises instructions to modify the one or more sub-child data sets, store the modified sub-child data sets separately in the local memory as a version of the one or more sub-child data sets, and enable access to the parent data file with and without the modified sub-child data sets. Access to the child data set with and without the modified sub-child data sets may also be provided.

The instruction set further comprises instructions to determine if at least one parameter of the modified child data set crossed a threshold limit. If determined then divide the modified child data set into two or more new data sets based on the threshold limit. Thereafter, store the new child data sets separately as a version of the modified child data set and enable access to the parent data file with the modified child data set and with the new child data sets.

The instruction set further comprises instructions to determine if at least one parameter of the modified child data set is below a threshold limit. If determined, then join the modified child data set with its sequential child data set to form a new child data set.

Thereafter, store the new child data set separately as a version of the modified child data set and enable access to the parent data file with the modified child data set and with the new child data set.

In addition to the aforementioned embodiments, the present invention has the following advantages.

The present invention reduces data redundancy and saves storage space requirements, which leads to reduced costs in purchasing and maintenance of expensive storage devices.

The present invention further saves time in processing of data that is to be stored on a storage device.

The present invention further saves bandwidth that is to be required to transfer data over network. This further reduces the time that is required in transferring data over network.

The present invention enhances data security and protects against data loss or data theft events.

The present invention supports multi-user access to a data file without clashing in reading or writing operations. This enables users to collaborate on same project without clashing.

These and other aspects, characteristics and advantages of the present disclosure will be better understood with reference to the following description, drawings and attached claims. The drawings, which are integrated and form part of the present description, show some forms of embodiment of the present disclosure, and together with the description, are intended to describe the principles of the disclosure.

### BRIEF DESCRIPTION OF THE DRAWINGS

The above and still further features and advantages of the present disclosure will become apparent upon consideration of the following detailed description of embodiments thereof, especially when taken in conjunction with the accompanying drawings, and wherein:

FIG. 1 illustrates an exemplary environment in which various embodiments of the present disclosure are implemented.

FIG. 2 illustrates a block diagram depicting a hierarchical structure in which multiple versions of multiple files are stored in a memory for access over a network, in accordance with an embodiment of the present disclosure.

FIG. 3 illustrates a flow diagram of a method for editing a particular file from a database of plurality of files stored in the data server, in accordance with an embodiment of the present disclosure.

FIG. 4 illustrates a flow diagram of a method for modifying a particular chunk of a particular fork of a audio file, in accordance with an embodiment of the present disclosure.

FIG. 5 illustrates a flow diagram of a method for storing original version of a fork with or without modified chunk, in accordance with an embodiment of the present disclosure.

FIG. 6 illustrates a flow diagram of a method for modifying two or more sequential chunks from a audio file, in accordance with an embodiment of the present disclosure.

FIG. 7 illustrates a flow diagram of a method for splitting user modified version of a chunk in two or more chunks, in accordance with an embodiment of the present disclosure.

FIG. 8 illustrates a flow diagram of a method for automatically splitting modified version of a chunk in two or more chunks, in accordance with an embodiment of the present disclosure.

FIG. 9 illustrates a flow diagram of a method for modifying a child data set of a parent data file, in accordance with an embodiment of the present disclosure.

FIG. 10 illustrates a flow diagram of a method for dividing a modified child data set into two or more new data sets based on a threshold limit, in accordance with an embodiment of the present disclosure.

FIG. 11 illustrates a flow diagram of a method for joining a modified child data set with its sequential child data set to form a new child data set, in accordance with an embodiment of the present disclosure.

FIG. 12 illustrates a block diagram of a communication apparatus, in accordance with an embodiment of the present disclosure.

FIG. 13 illustrates a block diagram depicting different operations which may be performed on modified sub-child data sets, in accordance with an embodiment of the present disclosure.

### DETAILED DESCRIPTION OF SOME FORMS OF EMBODIMENT

The description shall now refer in detail to the various forms of embodiment of the present disclosure, of which one or more examples are shown in the attached drawings. Each example is supplied by way of illustration of the invention and shall not be understood as a limitation thereof. For example, the characteristics shown or described insomuch as they are part of one form of embodiment can be adopted on, or in association with, other forms of embodiment to produce another form of embodiment. It is understood that the present disclosure shall include all such modifications and variants.

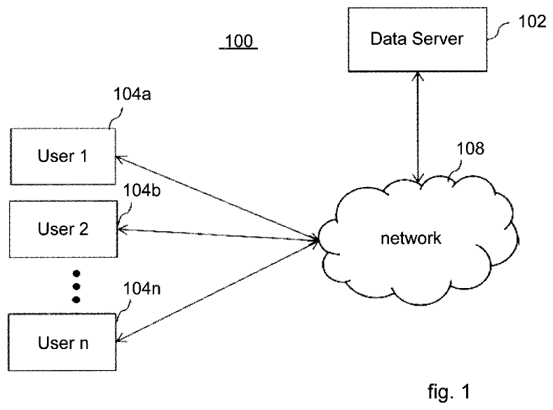

FIG. 1 illustrates an exemplary environment 100 where various embodiments of the present disclosure are implemented. The environment 100 includes a data server 102 connected to a plurality of electronic devices 104a-n via a network 108, wherein the number n is an arbitrary number representing same or different number of devices. Hereinafter, the devices 104a-n may collectively be referred to as “user devices 104”.

Further, the user devices 104 may refer to electronic devices that may be utilized by users to access and communicate with the data server 102. Examples of the user devices 104 may include, but are not restricted to communication devices such as cell phones, tablets, laptops, desktop computers, etc that are capable of connecting with the network 108.

The network 108 may include, but is not restricted to, a communication network such as Internet, Intranet, PSTN, Local Area Network (LAN), Wide Area Network (WAN), Metropolitan Area Network (MAN), and so forth. The network 108 may be used to connect the user devices 104 to the data server 102 with the help of the service application or the website.

In an embodiment of the present disclosure, the user devices 104 are installed with a service application (optional and not shown). The service application may be implemented as a software application (or combination of software and hardware). Further, the service application installed in the user devices 104 is configured to connect the user devices 104 with multiple services offered by the data server 102.

In another embodiment of the present disclosure, the user devices 104 may be used to access the data server 102 via a web platform (e.g., a website). The website may include any online platform which provides access to the data server 102. Further, the website may be configured to allow the user devices 104 to access various services offered by the data server 102. Examples of the data server 102 may include, but is not restricted to a cloud server, web server, local server, etc.

In an exemplary embodiment of the present disclosure, the data server 102 is configured with a versioning system (not shown). The versioning system may be comprised of hardware, software, or a combination of thereof. Further, the versioning system (hereinafter may intermittently referred as ‘the system’) is configured for collaborating music files and correlated data based on a cloud platform. The versioning system is further configured for creating and managing multiple versions of the music files and correlated data by ensuring lowest possible memory requirements in storing all the versions of the music files and correlated data in the data server 102.

It will be appreciated by a person skilled in the art that the example of music files is used only for ease of describing the present disclosure. However, the scope of the present disclosure is not limited to music files only. The present disclosure is capable of managing any file format and any file type on a local or cloud storage platform.

Further, the versioning system of the data server 102 ensures that files are efficiently stored in the data server 102 and can be retrieved for editing or modifications. Any modifications or changes in the files or in its attributes are saved in the data server 102 as a new version of the file. The new and the original versions are also made available for immediate access to local or remote users.

The new version may comprise modified data such as, but not restricted to, date, version number, editor name, and many other metadata that can be defined in flexible manner. The system therefore stores history of all different versions of a file for enabling access to any specific version of the file.

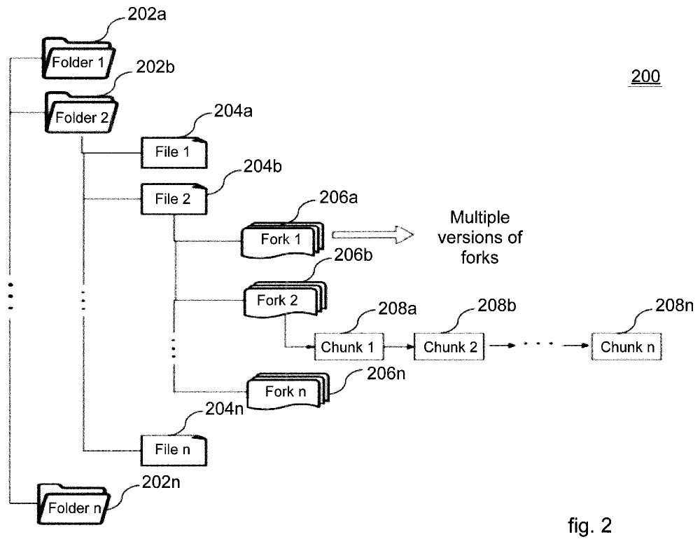

More details corresponding to the functionality of the data server 102 and its versioning system are defined further in conjunction with FIG. 2-13 of the present disclosure.

FIG. 2 illustrates a block diagram 200 illustrating a hierarchical structure in which multiple versions of multiple music files are stored in a memory of a data server (e.g., data server 102) for access over a network (e.g., network 108). As depicted from the block diagram 200, multiple versions of the multiple music files (204a-n) are stored in multiple folders (202a-n) in the data server.

The multiple folders (202a-n) may store multiple versions of the multiple files (204a-n) stored in the data server. The multiple files (204a-n) stored in the multiple folders (202a-n) may include, but is not restricted to, audio files, graphical files, video files, text files, or a combination thereof. However, as part of an embodiment of the present disclosure, the FIG. 2 is illustrated with an exemplary scenario wherein folder 2 (202b) comprises multiple music files (audio files) 204a-n.

The multiple music files 204a-n may be composed of multiple forks (forks 206a-n of music file 204b). The multiple forks 206a-n may further be composed of multiple chunks 208a-n, wherein ‘n’ represents any arbitrary number representing same or different number of folders, files, forks or chunks. The number of chunks and forks available in a music file is not related or proportional to each other and can be different in count.

Every music file is composed by a set of independent “forks” that store individual component of the music file. For example, a music track or metadata related to a file. Every fork is composed by a list of one or more “chunks” (blocks) of data that is obtained by splitting the fork following specific criteria (e.g., by chunks of equal size). This hierarchical structure provides flexibility and efficiency for versioning operations on files, forks, and chunks.

The forks contained in a musical file can be represented in different digital formats such as, but not restricted to, raw data, standard musical notation, midi, etc. For example, music files may be ‘forked’ by different users in order to have different editing paths that can be further merged. The data server is specifically configured for creating, storing, and managing different file versions divided by ‘chunks’ by efficiently managing memory space.

Further, a set of attributes may be associated to each file, fork, and chunk.

Each attribute may composed by a key and a tuple of arbitrary values.

Attributes enrich single project elements with arbitrary information such as author, last modified date, creation date, file format, compression, location, musical instrument, etc.

Another arbitrary information can reports which author worked on a parent data file and/or a child data file and/or a sub-child data file. For example, the arbitrary information can reports which author or authors have worked on a specific music file.

These information may be used by an automatic mechanism to calculate and provide the rights ownership, expressed for example as a percentage, for each author that has worked on the specific data file. The automatic mechanism is able to calculate also the amount of money for each author that has worked on the specific file.

According to a variant, the arbitrary information may be also used as such by an user, for example to calculate manually the amount of money for each author that has worked on the specific file.

The apparatus may comprise also the automatic mechanism.

A further indexing mechanism is applied to attributes and chunk's contents in order to perform accurate classification of those attributes, in this way searching and retrieving tasks can be performed more efficiently.

In an exemplary embodiment of the present disclosure, the data server is configured to provide an ability of managing different versions of a single fork or entire file (i.e., all forks). For example, after performing certain editing to an individual fork of a music file, a user may decide to save new version of edited fork separately with a unique name. Unchanged chunks remain same for the new version and edited chunks are further splitted or rejoined according to specific chunk split and join criteria set for a music project. The user can also select to save the entire musical file as a version by grouping current versions of all the forks in the file. It is to be understood that any two file versions are different if they contain at least one fork whose contents/chunks/attributes are different.

Further, regardless of data format contained in a fork, the data chunks are the atomic components that compose it. After uploading a new fork to the data server, the data server automatically splits fork data into a linked list of chunks.

The number of chunks depends on the size of byte array representing the fork and each chunk is at most of size N bytes, where N is a parameter that can be configured by user.

Other split criteria is based on extraction of specific pieces of the track structure after parsing of file data formats. Each time a chunk is edited, the data server marks it as changed. Once the user decide to save the fork as a new version, the data server transform the edited chunks and keeps unchanged chunks by adding a link to the new version without been duplicated. This way the data server efficiently maintains history of all versions by saving a considerable amount of storage space, especially when the number of modified chunks is small.

Further, the data server makes it possible to retrieve any specific version of the current fork by just following the links between chunks tagged with that version. This reduces memory requirements in storing multiple versions as only modified data is stored separately and is linked with original data without keeping a copy of the original data.

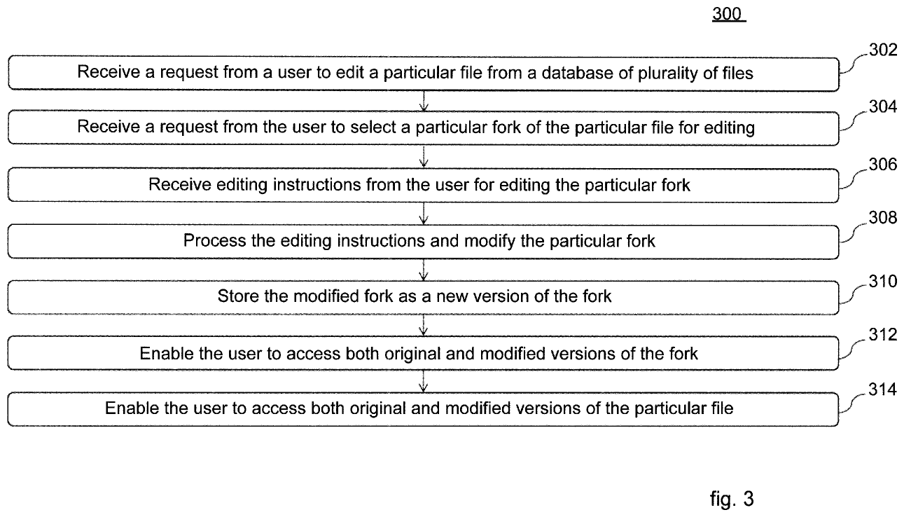

FIG. 3 illustrates a flow diagram 300 of a method for editing a particular file stored in a database of a data server (such as the data server 102), in accordance with an embodiment of the present disclosure. The file can be accessed and edited by a local user or by a remote user over a network (such as the network 108). The file may comprise any data, but is not restricted to, audio, video, graphics, text, or a combination thereof. Editing/modification of a file comprises, but is not restricted to, modifying data stored in the file, adding data in the file, deleting data from the file, replacing the file or part of the file, deleting the file or part of the file, modifying metadata of the file, modifying properties of the file, modifying attributes of the file, etc. Overall, any change in original file corresponds to editing or modification of the file.

Referring now to the step 302 of the flow diagram 300, a request from a user (local or remote) is received by the data server to edit a particular file (out of plurality of files) that is stored in a database of the data server. For example, if a user (musician) has stored his/her music creations (as files) in database of the data server, the user may wish to edit a particular music file to create a new version of it.

At step 304, another request from the user is received to select a particular fork of the selected file for editing purpose. For example, in case the user has plurality of audio files stored in the database of the data server 102. The user may wish to edit a specific fork (component) of the particular audio file. At step 306, editing instructions from the user are received for editing the particular fork. The user may use the data server's processing abilities to edit the fork that is stored in the database of the data server.

At step 308, the editing instructions received from the user are processed by the data server to modify the particular fork as per the editing instructions. For example, if the user wishes to edit the selected fork (tune) by adding a pitch to the tune. The editing instructions for editing the selected fork (tune) are processed to modify the selected fork accordingly.

At step 310, the modified fork is stored separately as a new version of the fork. For example, the modified tune (fork) with added pitch is stored as a new version of the tune (fork). However, it is to be noted that the new version of the fork only comprise data that is modified. The unmodified data is referred from the original fork by linking original data with the modified data. This way a lot of memory space is saved by avoiding redundancy in data storage.

At step 312, the data server provides access to both original and modified versions of the fork to local or remote users. The modified version of the fork is stored as the new version by adding a link to the original version of the fork. Therefore, the user may access both the original and the modified version of the fork by following the links between the original and modified versions of the fork. The linking process enables in combining modified data with the data that is not modified. This way a user can have access to the original fork with and without the modified data.

For example, the modified fork with added pitch is stored as the modified version of the fork by adding a link to the original fork of the particular audio file i.e. the original tune without added pitch. Therefore, the user may access both the original and modified versions of the fork by following the links between the modified versions of the fork.

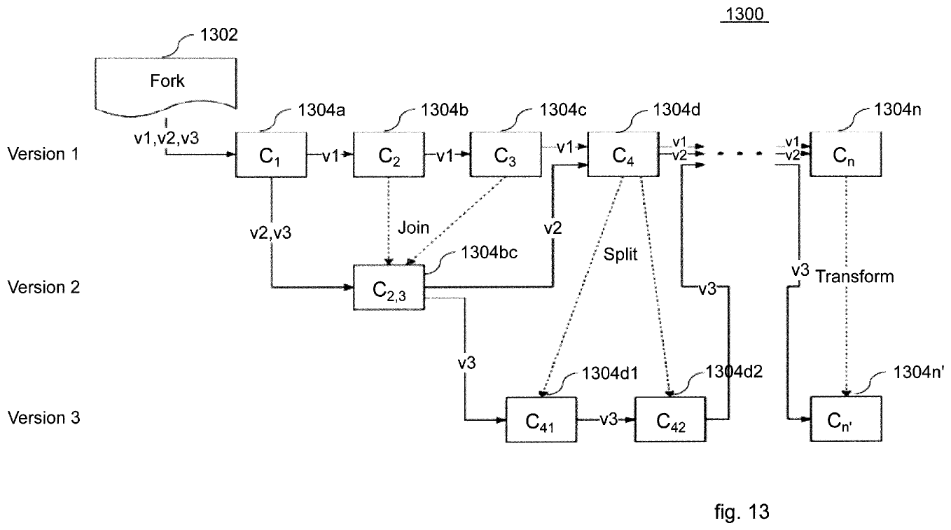

Similarly, at step 314, the data server may allow access to the original file (with multiple forks) with original fork as well as with the modified fork. It is to be noted that while accessing the file with modified fork, the data server will access only the modified data in the fork and will connect to the remaining portions of the fork from the original copy of the fork. More details on linking of modified data with unmodified data is disclosed further in conjunction with FIG. 13 of the present disclosure.

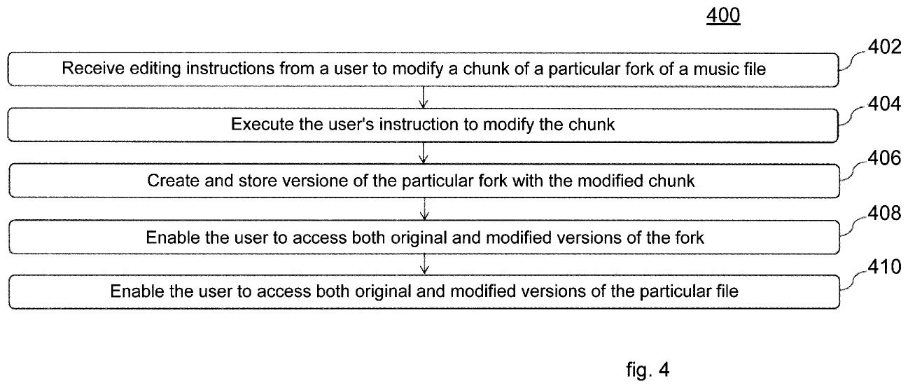

FIG. 4 illustrates a flow diagram 400 of a method for modifying a particular chunk of a particular fork of an audio file, in accordance with an embodiment of the present disclosure. At step 402, editing instructions are received from a user by a data server to modify a particular chunk of a particular fork of an audio file. The data server executes the user's instruction to modify the chunk at step 404 by using its processing capabilities. Thereafter, at step 406, the data server may store the modified chunk separately as modified version of the chunk and may allow access to both the original and modified versions of the fork to a local or remote user. Similarly, at step 410, access to the file is provided to the user with or without the modified version of the fork, based on user's requirements.

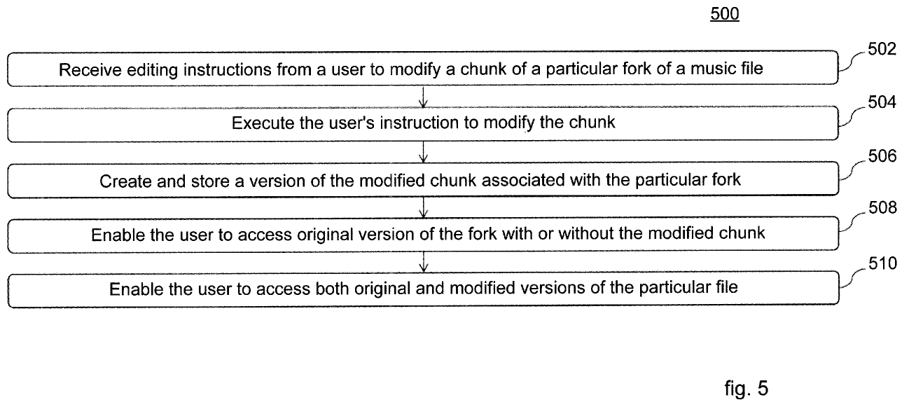

FIG. 5 illustrates a flow diagram 500 of a method for storing original version of a fork with or without modified chunk, in accordance with an embodiment of the present disclosure. At step 502, editing instructions are received by a data server from a user to modify a chunk of a particular fork of an audio file that is stored in a database of the data server.

At step 504, the user's instructions to modify the chunk are executed by the data server. For example, the user may request to edit the particular chunk (e.g., a specific portion of a guitar tune). The specific/complete portion of the chunk then gets modified by the data server as per the users instructions. The data server may be configured to manage editing requests by the users with the help of related algorithms, programs, or software pre-installed in the data server.

At step 506, the data server stores the modified chunk as a separate version of the chunk in its database. The modified version of the chunk is link-able to rest part of its fork in order to allow any user to access the complete fork with or without the modified chunk, at step 508. Similarly, at step 510, the data server enables any user to access the music file with or without the modified chunk. By storing copy of only the modified data and then linking the modified data with the rest of the unmodified file, the data server meets the demand of efficiently managing storage space by keeping data redundancy under check. More details on linking of modified data with unmodified data is disclosed further in conjunction with FIG. 13 of the present disclosure.

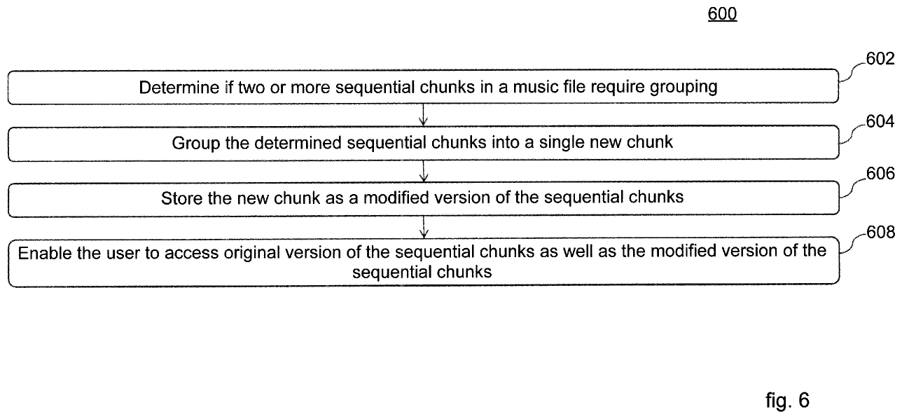

FIG. 6 illustrates a flow diagram 600 of a method for joining two or more sequential chunks from an audio file, in accordance with an embodiment of the present disclosure. At step 602, a data server analyses its database storing plurality of audio files to identify a file, wherein parameters of certain chunks are below a threshold limit. Thereafter, at step 604, the data server groups (combine or join) the determined chunks with their sequential chunks.

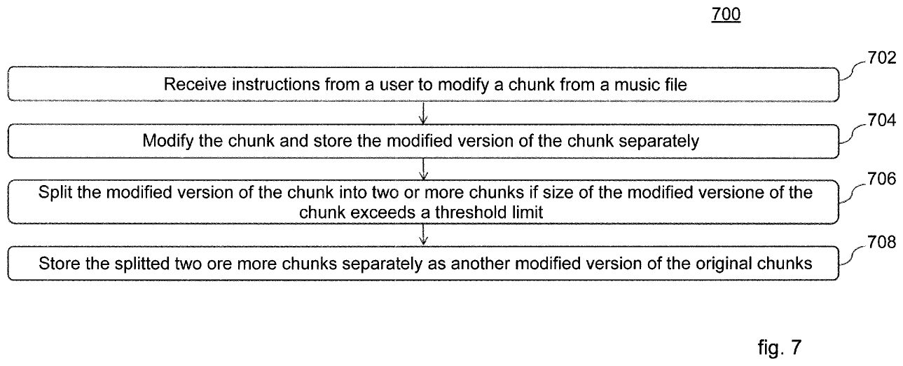

For example, chunks of the file might require to be of a particular size and chunks with a lesser size may require grouping with their sequential chunks to meet the threshold size limit. If after grouping, the size of chunks is exceeded above a threshold limit, then the grouped chunk may require splitting to meet the size threshold levels. This process of splitting is defined further in conjunction with FIG. 7 of the present disclosure.

At step 606, the grouped versions of the sequential chunks are stored separately as a copy of the original chunks. It is to be understood that the original chunks are not modified but a copy of their is modified and stored separately as a version of the original chunks. Thereafter, at step 608, the data server allows access to the original chunks as well as to the modified or grouped chunks to a local or remote user. The user may access the chunks only or may access the chunks with rest of its fork or as a complete music file.

FIG. 7 illustrates a flow diagram 700 of a method for splitting a chunk, in accordance with an embodiment of the present disclosure. At step 702, a data server receives instructions from a user to modify a particular chunk of a particular fork of a music file. The data server modifies the chunk as per the user's instructions at step 704. Further, the modified copy of the chunk is stored separately in database of the data server so as to retain the original copy of the chunk as well.

Thereafter, at step 706, the data server may detect that one of the parameter of the modified version (copy) of the chunk has exceeded a threshold parameter. The threshold parameter may be set by a user. For example, the parameter could be size of the chunk. Thereafter, the data server may split the chunk into two or more chunks to meet the threshold parameter. The splitted copies of the chunks are stored separately in database by retaining the original copy of the splitted chunk as well, at step 708. Further, the data server allows access to the user to both the original as well as splitted chunks. This way user can track all the modifications performed on any particular chunk from the history of modifications saved by the data server.

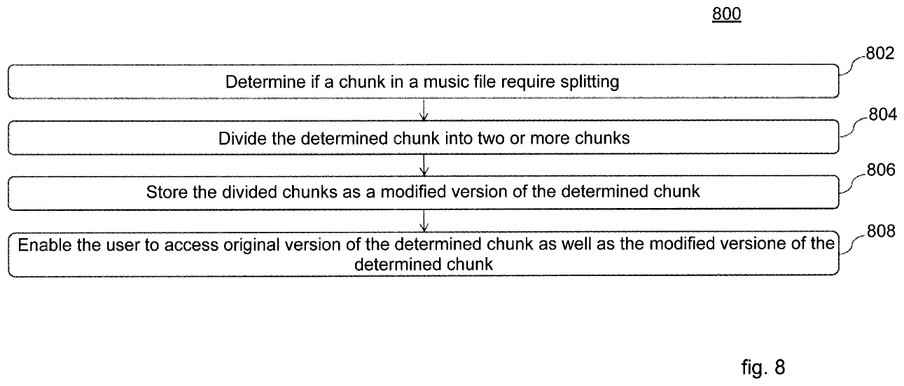

FIG. 8 illustrates a flow diagram 800 of a method for automatically splitting a chunk of an audio file, in accordance with an embodiment of the present disclosure. At step 802, a data server analyses files stored in its database for determining a music file, wherein one or more chunks of the file are above a threshold level. The chunks may have several parameters such as size, time, type, etc. These parameters may have pre-defined threshold levels that can be set by users. If any of the threshold level is exceeded, the data server may be configured to trigger actions.

At step 804, the data server triggers an action of creating a copy of a determined chunk for splitting. Thereafter, the data server divides the copy of the determined chunk in two or more separate chunks in adherence to the threshold levels of pre-defined parameters. The divided copy of the determined chunk is stored separately in database of the data server, at step 806. Thereafter, the original copy and the divided copy of the chunk are made available for access to a local or remote user, at step 808.

For example, if the data server determined that size of a particular chunk is exceeded than a threshold limit then the data server may divide a copy of that chunk into multiple smaller chunks of equal sizes, as per the size threshold limit. Further, if after splitting of the chunks, size of any splitted chunk is reduced below a threshold level, then the data server may join the smaller chunk with its sequential chunk to maintain a threshold size, the same process is described in detail in conjunction with FIG. 7 of the present disclosure.

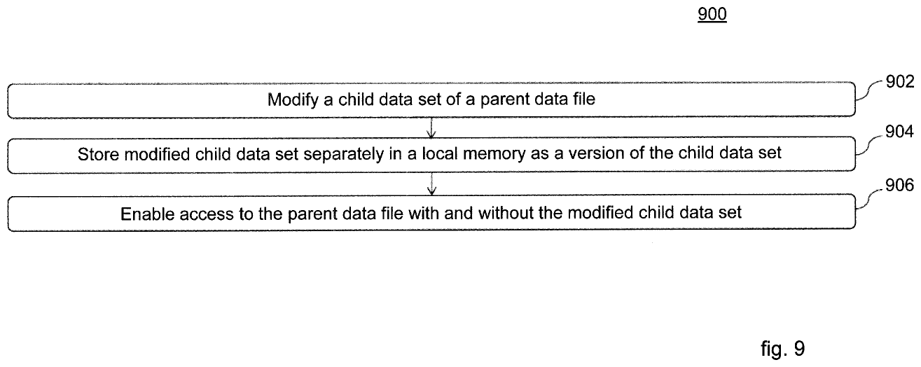

FIG. 9 illustrates a flow diagram 900 for remotely modifying a data file stored on a data server, in accordance with an embodiment of the present disclosure. The data server may have a database storing a plurality of files comprising various types of data such as text, audio, video, graphics, or a combination thereof. The data server may further be configured to allow a local user or a remote user to access the files stored in the database and to perform actions such as, but not restricted to, addition, deletion, modification, etc.

Each file stored in the database may further be composed of various parts that can further be sub-divided. For easy reference, any file stored in the database of the data server may hereinafter be referred to as ‘parent file’. Further, the parent file is considered to be capable of dividing into child data sets. It is to be understood that if all child data sets are combined in hierarchical manner, the parent file can be obtained. Similar way, the child data sets are also capable of being divided into sub-child data sets. For example, a music file can be divided into multiple forks and each fork can be sub-divided into multiple chunks.

In another example, a text file with graphics may be divided into a set of text data and a set of graphical data. The text file may also be divided into multiple chapters or into a set of pages etc. Similarly, a video file may be divided into separate video data, audio data, text data (captions). It will be appreciated by a person skilled in the art that although the description is drafted with a primary example of music files comprised of forks and chunks, the same must not be considered as limiting the scope of the disclosure. All types of data files are included herein under the scope of the present disclosure.

More specifically, the method relates to management of a local memory of an electronic device (such as the data server 102) storing a plurality of parent data files, wherein the parent data files are composed of a plurality of child data sets.

The method enables the electronic device to modify a child data set of a parent data file and then to store modified child data set separately in the local memory as a version of the child data set. This enables the electronic device to allow access to the parent data file with and without the modified child data set, to any local or remote user. The method is described below in detail with an example of music files being the parent data files, forks being as the child data set, and chunks being as the sub-child data sets.

Referring now to the flow diagram 900, at step 902 the data server receives a request from a remote user (over a network) to modify a parent data file. More specifically, the user request comprises a specific child data set of the parent file that is to be modified as per the user's instruction. The data server thereafter processes the user's instructions and for modifying the parent file's particular child data set. The process of remotely modifying any file over a network is known in the art and therefore is not detailed. Any person skilled in the art must have the basic knowledge of the same.

At step 904, the modified child data set is stored in a local memory of the data server as a version of the child data set. Herein, the modifications are made on a copy of the child data set and not on the child data set itself. Further, the original child data set is retained in the memory along with the modified copy and is referred herein as a version of the original child data set. The modified child data set copy is stored in the local memory as the version of the child data set by adding a link to the original child data set. The link enables the data server to access the parent data file with or without the modified child data set.

More specifically, other child data sets of the parent data file can be linked with the original copy of the modified data set and can also be linked with the modified copy itself. Based on requirement, the parent data file can be accessed with or without modified child data set, at step 906. It is to be understood that the child data set of the parent data file is further divisible into one or more sub-child data sets.

The data server is also capable of modifying one or more sub-child data sets of the parent data file on user's request. After user requested modifications, the data server may store the modified sub-child data sets separately in the local memory as a version of the one or more sub-child data sets, to enable access to the parent data file with and without the modified sub-child data sets. The data server may further enable access to the child data set with and without the modified sub-child data sets.

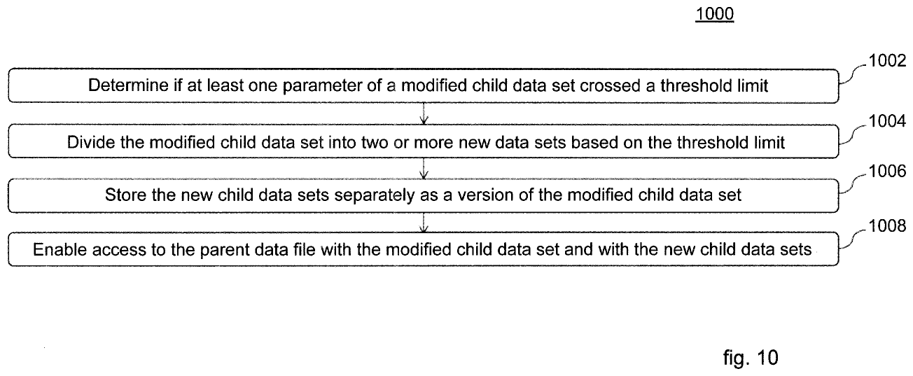

FIG. 10 illustrates a flow diagram 1000 for dividing a modified child data set into two or more new data sets based on a threshold limit, in accordance with an embodiment of the present disclosure. The flow diagram 1000 is in continuation of the flow diagram 900 and all the terminologies are inherited herein from the description of flow diagram 900. Referring now to the step 1002 of the flow diagram 1000, it is determined by the data server if at least one parameter of a modified child data set crossed a threshold limit for triggering an action. In an embodiment, the user may have an option to set the threshold limit for child data sets based on different parameters such as file size, file type etc.

At step 1004, if it is determined that the modified child data set has crossed a threshold then the data server divides the modified child data set into two or more data sets, based on the threshold limit defined by the user. At step 1006, the new child data sets (divided copy of the original) are stored separately as a version of the modified child data set. The new child data sets are stored separately by adding a link to the modified data set for determination of multiple versions of the modified data set.

At step 1008, the user may be able to access the parent data file with the modified sub-child data set as well as with the new child data sets. The new child data sets are stored with the modified child data set by adding the link to the new child data sets. Therefore, the user may access the parent file with the modified child data set and with the new child data sets by following the links between the modified data set and the new child data sets. In an alternate embodiment, the same process may also be valid with sub-child data sets of a child data set. For example, if at least one parameter of a sub-child data set crossed a threshold limit, the sub-child data set may be divided into two or more sub-child data sets based on the threshold limit.

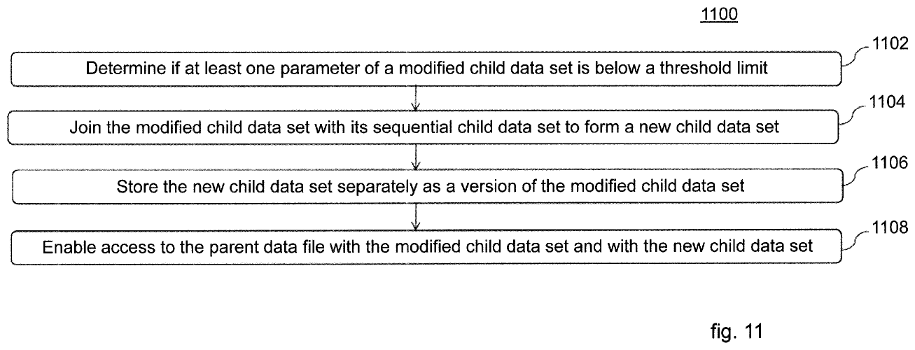

FIG. 11 illustrates a flow diagram 1100 of a method for joining a modified child data set with its sequential child data set to form a new child data set, in accordance with an embodiment of the present disclosure. The flow diagram 1100 is in continuation of the flow diagram 900 and all the terminologies are inherited herein from the description of flow diagram 900 and 1000.

Referring now to the step 1102 of the flow diagram 1100, it is determined if at least one parameter of a modified child data set is below a threshold limit. At step 1104, if the modified child data set is determined below the threshold limit then the data server may automatically join the modified child data set with its sequential child data set(s) to form a new child data set that meets the threshold limit. At step 1106, the new child data set is stored separately as a version of the modified child data set. Further, the new child data set is stored separately by adding a link to the modified data set.

At step 1108, the data server may allow the user to access the parent data file with the modified child data set as well as with the new child data set. The new child data sets are stored with the modified child data set by adding the link to the new child data set. Therefore, the user may access the parent file with the modified child data set and with the new child data set by following the links between the modified data set and the new child data sets. In an alternate scenario, the same process may be valid with sub-child data sets of the child data sets.

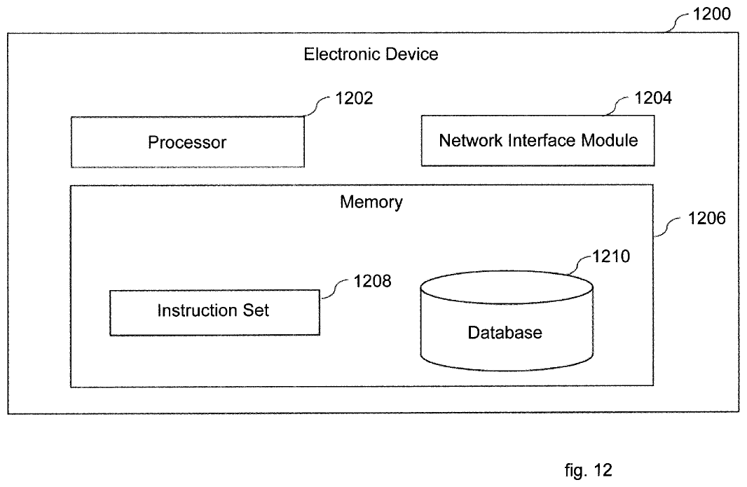

FIG. 12 illustrates a block diagram of an electronic device 1200 (such as the data server 102), in accordance with an embodiment of the present disclosure. The electronic device may be any electronic device such as, but not restricted to, laptop, desktop computer, mobile phone, tablet, server, etc. As depicted from the figure, the electronic device 1200 comprises a processor 1202, a network interface module 1204, and a memory 1206 for data storage. The network interface module 1204 is used for connecting the electronic device 1200 with a network (such as the network 108). The processor 1202 may comprise one or more than one processors. The network interface module 1204 may be a hardware, a software, or a combination thereof.

The memory 1206 further comprises an instruction set 1208 and a database 1210. The instruction set 1208 stored in the memory 1206 uses the processor 1202 to perform actions, e.g., receiving, storing, processing, and transmitting data stored in the memory 1206. In an embodiment of the present disclosure, the memory 1206 may be a non-transitory volatile or a non-volatile memory. For example, but not restricted to, random access memory (RAM), cache memory, hard disk drive (HDD), solid state drive (SSD), compact disk (CD), portable memories, and like.

The database 1210 comprises a plurality of parent data files that are composed of a plurality of child data sets. The instruction set 1208 comprises instructions which when executed by the one or more processors causes the electronic device 1200 to modify a child data set of a parent data file, store modified child data set separately in the local memory as a version of the child data set, and enable access to the parent data file with and without the modified child data set. The child data set of the parent data file is further divisible into one or more sub-child data sets.

The instruction set 1208 further comprises instructions to modify the one or more sub-child data sets, store the modified sub-child data sets separately in the local memory as a version of the one or more sub-child data sets, and enable access to the parent data file with and without the modified sub-child data sets. Access to the child data set with and without the modified sub-child data sets may also be provided.

The instruction set 1208 further comprises instructions to determine if at least one parameter of the modified child data set crossed a threshold limit. If determined then divide the modified child data set into two or more new data sets based on the threshold limit. Thereafter, store the new child data sets separately as a version of the modified child data set and enable access to the parent data file with the modified child data set and with the new child data sets.

The instruction set 1208 further comprises instructions to determine if at least one parameter of the modified child data set is below a threshold limit. If determined, then join the modified child data set with its sequential child data set to form a new child data set. Thereafter, store the new child data set separately as a version of the modified child data set and enable access to the parent data file with the modified child data set and with the new child data set.

More details corresponding to the joining and splitting of the child data sets are explained further in conjunction with FIG. 13 of the present disclosure, wherein the parent file is referred with an example of a music file, the child data set is referred to as a fork, and the sub-child data sets are referred to as chunks.

Referring now to FIG. 13, a representative structure of memory storage is illustrated to define a manner in which a data server may store version history of music files. Illustrated is a single fork 1302 of a music file (not shown). The single fork 1302 is further illustrated to be formed by a plurality of chunks 1304a-n. The plurality of original chunks 1304a-n are referred here as part of version 1 of the fork 1302. Any modification in the chunks may be stored separately and the fork 1302 may be accessed with the modified chunks as version 2 of the fork 1302. Any further modification in the fork will create version 3 and so on.

It is to be understood that although any modification in a fork is accounting to a new version of the fork, still all chunks of the fork are not stored in the new versions and only modified chunk is stored separately. The data server links the modified data with unmodified data and therefore allows access to multiple versions of the same fork without having to create redundancy in data storage.

Further as illustrated, chunks 1304b and 1304c are joined to form a single chunk 1304bc. Fork 1302 with the modified chunk. 1304 can be accessed easily by referring to version 2 of the fork 1302. Similarly, chunk 1304d is splitted into two new chunks 1304d1 and 1304d2 and forms version 3 of the fork 1302. Any further modifications in the chunks may result in further versions of the fork 1302.

Although the present disclosure has been described in terms of certain preferred embodiments, various features of separate embodiments can be combined to form additional embodiments not expressly described. Moreover, other embodiments apparent to those of ordinary skill in the art after reading this disclosure are also within the scope of this invention. Furthermore, not all of the features, aspects and advantages are necessarily required to practice the present disclosure. Thus, while the above detailed description has shown, described, and pointed out novel features of the invention as applied to various embodiments, it will be understood that various omissions, substitutions, and changes in the form and details of the apparatus or process illustrated may be made by those of ordinary skill in the technology without departing from the spirit of the invention.

The inventions may be embodied in other specific forms not explicitly described herein. The embodiments described above are to be considered in all respects as illustrative only and not restrictive in any manner. Thus, scope of the invention is indicated by the following claims rather than by the foregoing description.

The present disclosure is set forth and characterized in the independent claims, while the dependent claims describe other characteristics of the invention or variants to the main inventive idea.

1. A method to manage a local memory of an electronic device storing a plurality of parent data files, wherein the parent data files are composed of a plurality of child data sets, the method enables the electronic device to:
modify a child data set of a parent data file;
store modified child data set separately in the local memory as a version of the child data set; and
enable access to the parent data file with and without the modified child data set.

2. The method of claim 1, wherein the method further enables the electronic device to:
determine if at least one parameter of the modified child data set crossed a threshold limit;
divide the modified child data set into two or more new data sets based on the threshold limit;
store the new child data sets separately as a version of the modified child data set; and
enable access to the parent data file with the modified child data set and with the new child data sets.

3. The method of claim 1, wherein the method further enables the electronic device to:
determine if at least one parameter of the modified child data set is below a threshold limit;
join the modified child data set with its sequential child data set to form a new child data set;
store the new child data set separately as a version of the modified child data set; and
enable access to the parent data file with the modified child data set and with the new child data set.

4. The method of claim 1, wherein the child data set of the parent data file is further divided into one or more sub-child data sets.

5. The method of claim 4, wherein the method further enables the electronic device to:
modify the one or more sub-child data sets;
store the modified sub-child data sets separately in the local memory as a version of the one or more sub-child data sets; and
enable access to the parent data file with and without the modified sub-child data sets.

6. The method of claim 5, wherein it further enables access to the child data set with and without the modified sub-child data sets.

7. The method of claim 5, wherein it provides to retrieve arbitrary information related to a parent data file and/or a child data file and/or a sub-child data file in order to calculate and provide the rights ownership for each author that has worked on the specific data file, said rights ownership being expressed as percentages.

8. The method of claim 5, wherein the parent data file is an audio file.

9. The method of claim 5, wherein the child data set comprises at least one audio fork.

10. The method of claim 5, wherein the sub-child data sets comprise at least one audio chunk.

11. An apparatus connected with a network, the apparatus comprising:
one or more processors;
a network interface module for connecting the apparatus with the network;
a memory comprising:
a database comprising a plurality of parent data files, wherein the parent data files are composed of a plurality of child data sets;
an instruction set comprising instructions which when executed by the one or more processors causes the apparatus to:
modify a child data set of a parent data file;
store modified child data set separately in the local memory as a version of the child data set; and
enable access to the parent data file with and without the modified child data set.

12. The apparatus of claim 11, wherein the apparatus is further configured to:
determine if at least one parameter of the modified child data set crossed a threshold limit; and
divide the modified child data set into two or more new data sets based on the threshold limit;
store the new child data sets separately as a version of the modified child data set; and
enable access to the parent data file with the modified child data set and with the new child data sets.

13. The apparatus of claim 11, wherein the apparatus is further configured to:
determine if at least one parameter of the modified child data set is below a threshold limit; and
join the modified child data set with its sequential child data set to form a new child data set;
store the new child data set separately as a version of the modified child data set; and
enable access to the parent data file with the modified child data set and with the new child data set.

14. The apparatus of claim 11, wherein the child data set of the parent data file is further divided into one or more sub-child data sets.

15. The apparatus of claim 14, wherein it is further configured to:
modify the one or more sub-child data sets;
store the modified sub-child data sets separately in the local memory as a version of the one or more sub-child data sets; and
enable access to the parent data file with and without the modified sub child data sets.

16. The apparatus of claim 14, wherein it further enables access to the child data set with and without the modified sub-child data sets.

17. The apparatus of claim 15, wherein it comprises an automatic mechanism configured to retrieve arbitrary information related to a parent data file and/or a child data file and/or a sub-child data file in order to calculate and provide the rights ownership for each author that has worked on the specific data file, said rights ownership being expressed as percentages.

18. The apparatus of claim 14, wherein the parent data file is an audio file.

19. The apparatus of claim 14, wherein the child data set is an audio fork.

20. The apparatus of claim 14, wherein the sub-child data sets are audio chunks.

21. The apparatus of claim 11, wherein the apparatus is a server.

22. The apparatus of claim 11, wherein the apparatus is a mobile phone.
